(19) United States
(12) Patent Application Publication
(10) Pub. No.: US 2006/0089872 A1
(43) Pub. Date: Apr. 27, 2006

(54) Three step method for determining commissions

(76) Inventor: Donald Patrick Kannapel, Fredericksburg, IN (US)

Correspondence Address: Donald Patrick Kannapel, 10373 South Rudolph Road, Fredericksburg, IN, 47120, US

(21) Appl. No.: 10/969,200

(22) Filed: Oct. 21, 2004

(51) Int. Cl. G06Q 30/00

(52) U.S. Cl. 705/14

(57) ABSTRACT

The invention provides for a method for determining the commission to be paid to sales representatives in multi-tiered marketing structures. The three step method of positioning new associates in said marketing structures assures each associate greater opportunity to earn increased commissions.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1. Field of the Invention

This invention relates to the field of determining the sales commission provided to sales representatives.

2. Background Art

In modern business environments, it is commonplace to employ sales representatives to market the goods and services offered for sale. Sales representatives receive compensation based on a salary, the hours worked, and/or the goods or services sold. When basing compensation on the goods or services sold, sales representatives receive a commission that can be based on profits, net sales, the number of products sold, or some other variable.

To provide sales representatives with an incentive to sell as much as possible or to sell more of a desired product or products at certain prices, sales organizations create incentive plans wherein Commissions (Also known as Promotions) are provided or offered to the sales representatives when specific sales goals or targets are attained during a defined time period. For example, a Promotion may consist of paying a bonus of $100 for each new car sold in the month of May and $75 bonus for each used car sold in the month of May.

In addition, an incentive plan may apportion credit ((towards a Promotion) to everyone on a sales representative's sale team, to the representative's manager, or someone other than the sales representative himself. Providing credit to persons in a selling chain (i.e., an immediate supervisor, a manager, a senior manager, etc.) is referred to as an override or rolling up (a “roll-up”) the selling chain.

In today's competitive environment, companies thrive (and survive) on the basis of being able to quickly change and evolve. Multi-tiered commission structures have been invented and improved upon for many years and many of these marketing programs use the “roll-up” incentive structure as mentioned in paragraph (0003).

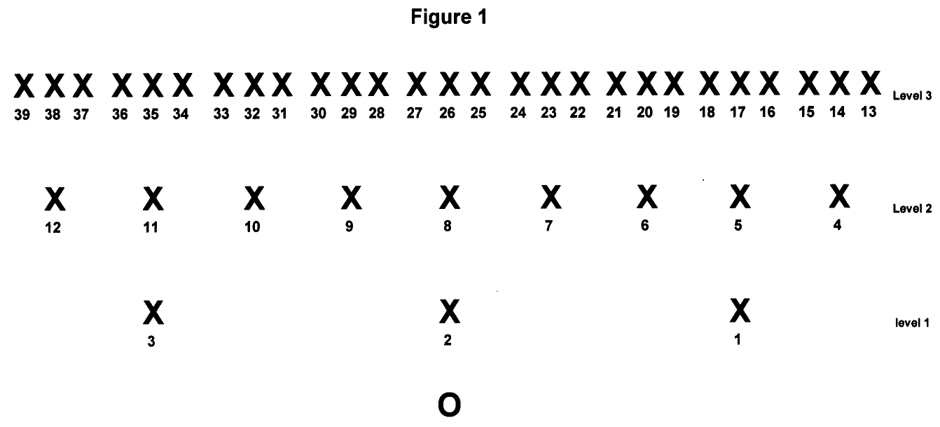

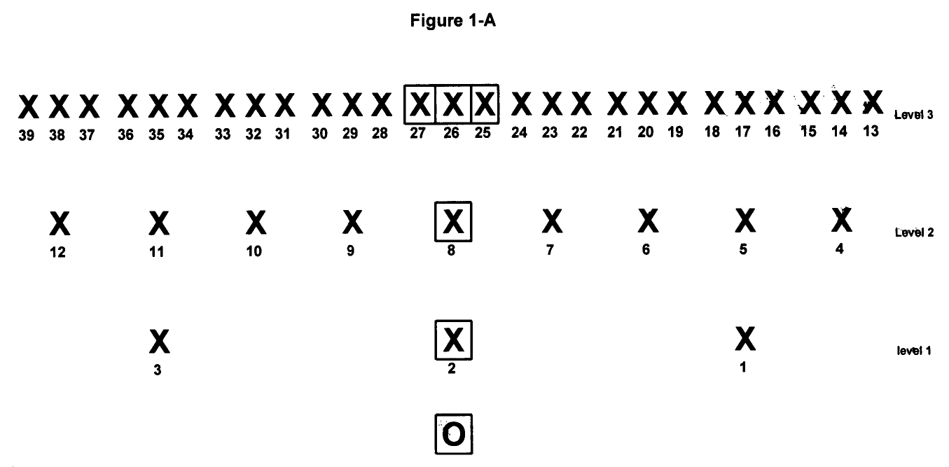

A multi-tiered incentive plan that I have been introduced to is now in public domain and such plan is what I have improved upon with my invention. Many marketing businesses are using this incentive structure at the present time and one such company, (AMWAY), was using this structure 27 years ago. See (FIG. 1): (0) represents each new associate and the 39 X's represent each associate's marketing bracket. The structure is set up to where each new associate that joins the business has three levels of commissions to achieve. On level 1, there are three positions where new associates recruited by each new associate, are placed; (X's 1, 2 and 3). On level 2, there are nine positions, (X's 4-12) that are filled with new associates recruited by the three associates on level 1. On level 3, there are twenty-seven positions, (X's 13-39) that are filled with new associates recruited by the nine associates on Level 2. Generally, each associate earns a higher percent of commission for placing associates on level 2 than level 1, and higher commission for placing associates on level 3 than level 2. Each associate has a total of 39 positions to earn commissions on with a three leveled commission structure. There are some marketing plans that pay commissions for more than three levels, but the structure is the same; each new associate must recruit three new associates. Most of these marketing plans have an incentive to where each new associate can earn more commission than he is investing each month after five new associates are strategically placed on the three levels. This is also known as the break-even point. See (FIG. 1-A). Instead of placing the first three associates on level one, the first three associates are placed directly above each other on X's 2, 8, and 26. Two additional associates must be placed on X's 25 and 27. When this is accomplished, said associate (0) is earning more money than he is investing each month. This, however, creates several problems. The first problem is that instead of you having to only recruit three new associates, you now have to recruit five. The second problem is that if you do place the first five recruited associates in these positions, then said associates will position most of their recruited associates beyond your marketing bracket and you will not receive commissions on said new recruits. This results in you personally having to recruit even more of the remaining thirty-four associates to fill your three levels and receive the maximum commissions possible. This is a few of the reasons this incentive structure has not been very successful over the years and has developed an unkind reputation in many sectors of the business world. With my Three Step Method for determining Commissions, the problems that I have mentioned are eliminated. Each new associate will only have to recruit three new associates. Each associate will have his five positions to break-even filled, and his remaining thirty-four positions will also be filled.

### BRIEF SUMMARY OF THE INVENTION

The Three Step Method for determining commissions, positions associates in a commissions structure using three steps, whereas such associates can earn more commissions in a shorter period of time than associates using the prior art.

With the Three Step Method for determining Commissions, the problems that I have mentioned in paragraph (0005) are eliminated. Each new associate will only have to recruit three new associates. Each associate will have his five positions to break-even filled, and his remaining thirty-four positions will also be filled.

### BRIEF DESCRIPTION OF THE SEVERAL VIEWS OF THE DRAWING

(FIG. 1) There are 39 X's: Each X represents a position where an associate will be positioned in the commission structure. There are three X's on level 1 numbered 1-3. There are nine X's on level 2 numbered 4-12. There are twenty-seven X's on level 3 numbered 13-39. There is also a (0) below X number 2 which represents the starting point of each new associate.

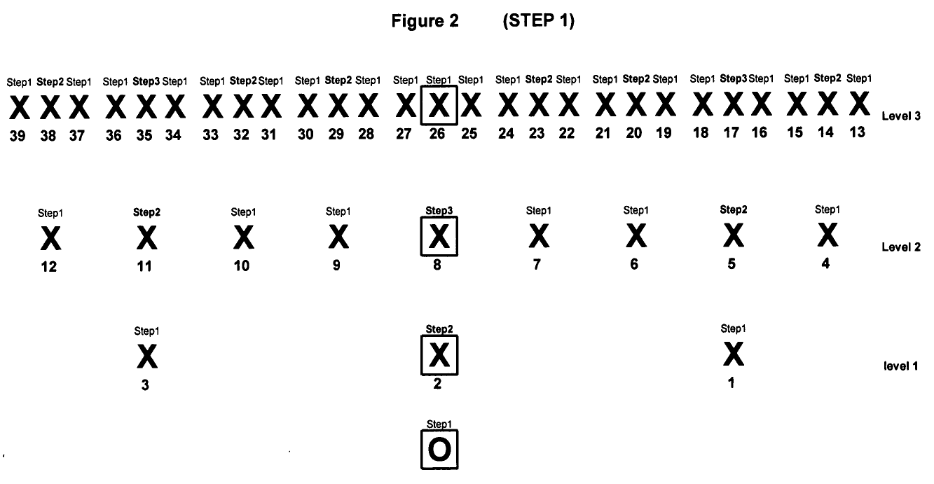

(FIG. 1-A) There are 39 X's: Each X represents a position where an associate will be positioned in the commission structure. There are three X's on level 1 numbered 1-3. There are nine X's on level 2 numbered 4-12. There are twenty-seven X's on level 3 numbered 13-39. There is also a (O) below X number 2 which represents the starting point of each new associate. A border boxing the (O) and X's numbered 2, 8, 25, 26, and 27 represent associates positioned to achieve the “break-even” point mentioned in (paragraph 0005). (FIG. 2) (Step 1). There are 39 X's: Each X represents a position where an associate will be positioned in the commission structure. There are three X's on level 1 numbered 1-3. There are nine X's on level 2 numbered 4-12. There are twenty-seven X's on level 3 numbered 13-39. There is also a (0) below X number 2 which represents the starting point of each new associate. Above the (0) and the 39 X's is the step that each associate must follow in positioning newly recruited associates. A border boxing the (O) and X's 2, 8, and 26 represents Step 1 and associate (O) positions his three recruited associates on X's 2, 8, and 26.

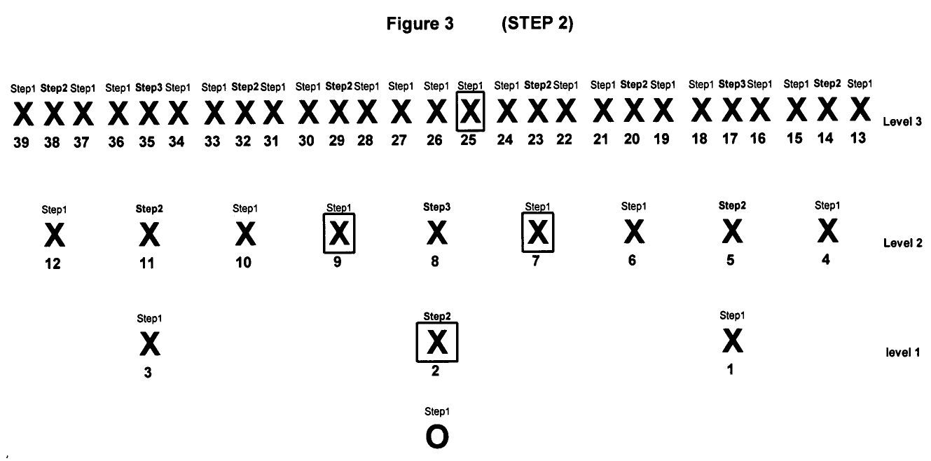

(FIG. 3) (Step 2). There are 39 X's: Each X represents a position where an associate will be positioned in the commission structure. There are three X's on level 1 numbered 1-3. There are nine X's on level 2 numbered 4-12. There are twenty-seven X's on level 3 numbered 13-39. There is also a (O) below X number 2 which represents the starting point of each new associate. Above the (O) and the 39 X's is the step that each associate must follow in positioning newly recruited associates. A border boxing X's 2, 25, 7, and 9 represents Step 2 where associate on X number 2 positions his three recruited associates on X's 25, 7, and 9.

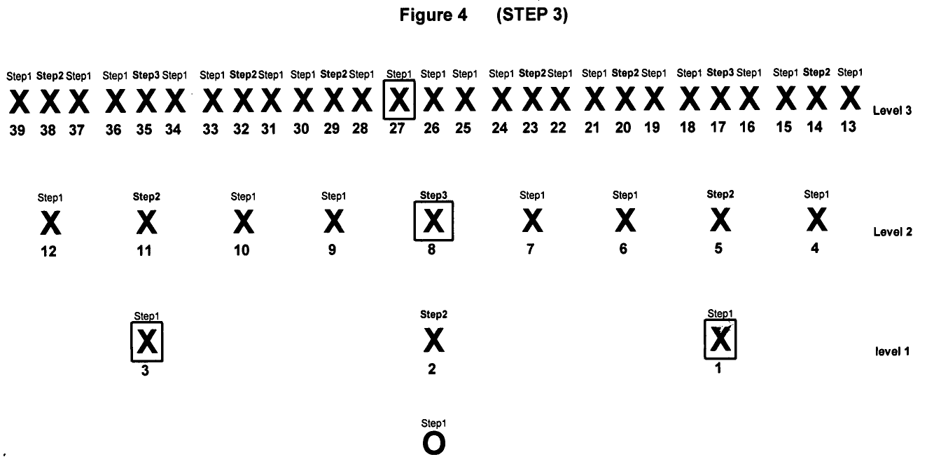

(FIG. 4) (Step 3). There are 39 X's: Each X represents a position where an associate will be positioned in the commission structure. There are three X's on level 1 numbered 1-3. There are nine X's on level 2 numbered 4-12. There are twenty-seven X's on level 3 numbered 13-39. There is also a (0) below X number 2 which represents the starting point of each new associate. Above the (O) and the 39 X's is the step that each associate must follow in positioning newly recruited associates. A border boxing X's 8, 27, 1, and 3 represents Step 3 where associate on X number 8 positions his three recruited associates on X's 27, 1, and 3.

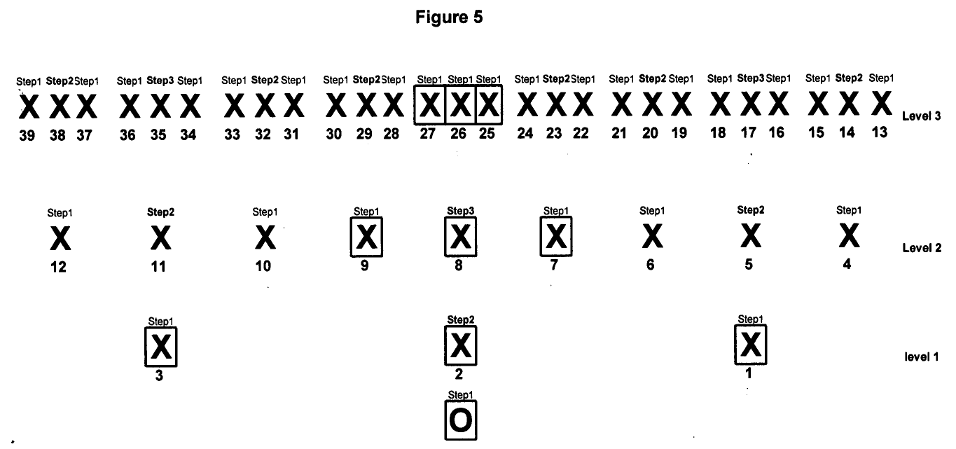

(FIG. 5) There are 39 X's: Each X represents a position where an associate will be positioned in the commission structure. There are three X's on level I numbered 1-3. There are nine X's on level 2 numbered 4-12. There are twenty-seven X's on level 3 numbered 13-39. There is also a (0) below X number 2 which represents the starting point of each new associate. Above the (O) and the 39 X's is the step that each associate must follow in positioning newly recruited associates. A border boxing (O) and X's 1, 2, 3, 7, 8, 9, 25, 26, and 27 represents a marketing bracket after Step 1, Step 2, and Step 3 have been completed once.

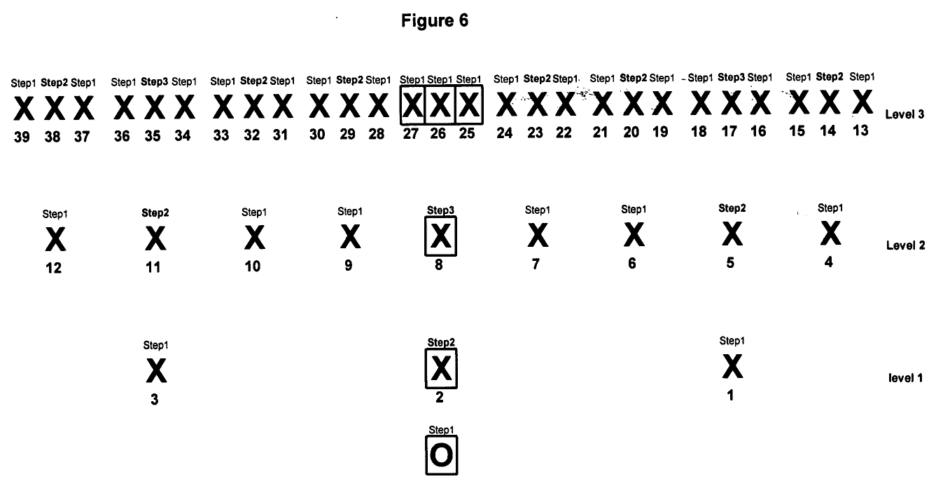

(FIG. 6) There are 39 X's: Each X represents a position where an associate will be positioned m the commission structure. There are three X's on level 1 numbered 1-3. There are nine X's on level 2 numbered 4-12. There are twenty-seven X's on level 3 numbered 13-39. There is also a (0) below X number 2 which represents the starting point of each new associate. Above the (O) and the 39 X's is the step that each associate must follow in positioning newly recruited associates. A border boxing the (O) and X's 2, 8, 26, 25, and 27 represents the “break-even” point mentioned in (paragraph 0005). Associate (0) recruits three associates; he places one associate on each of the three levels on numbers 2, 8, and 26. His first recruited associate on number 2, level 1, positions his first recruited associate on number 25, level three. His second recruited associate, number 8, level 2, places his first recruited associate on number 27, level 3. At this time, associate (0) is at the “break-even point”. This represents Step 1 and the first aspects of Step 2 and Step 3.

### DETAILED DESCRIPTION OF THE INVENTION

This paragraph describes an old multi-tiered incentive plan that I have been introduced to and is now in public domain; and such plan is what I have improved upon with my invention. Many marketing businesses are using this incentive structure at the present time and one such company, (AMWAY), was using this structure 27 years ago. See (FIG. 1): (0) represents each new associate and the 39 X's represent each associate's marketing bracket. The structure is set up to where each new associate that joins the business has three levels of commissions to achieve. On level 1, there are three positions where new associates recruited by each new associate, are placed; (X's 1, 2 and 3). On level 2, there are nine positions, (X's 4-12) that are filled with new associates recruited by the three associates on level 1. On level 3, there are twenty-seven positions, (X's 13-39) that are filled with new associates recruited by the nine associates on Level 2. Generally, each associate earns a higher percent of commission for placing associates on level 2 than level 1, and higher commission for placing associates on level 3 than level 2. Each associate has a total of 39 positions to earn commissions on with a three leveled commission structure. There are some marketing plans that pay commissions for more than three levels, but the structure is the same; each new associate must recruit three new associates. Most of these marketing plans have an incentive to where each new associate can earn more commission than he is investing each month after five new associates are strategically placed on the three levels. This is also known as the break-even point. See (FIG. 1-A). Instead of placing the first three associates on level one, the first three associates are placed directly above each other on X's 2, 8, and 26. Two additional associates must be placed on X's 25 and 27. When this is accomplished, said associate (0) is earning more money than he is investing each month. This, however, creates several problems. The first problem is that instead of you having to only recruit three new associates, you now have to recruit five. The second problem is that if you do place the first five recruited associates in these positions, then said associates will position most of their recruited associates beyond your marketing bracket and you will not receive commissions on said new recruits. This results in you personally having to recruit even more of the remaining thirty-four associates to fill your three levels and receive the maximum commissions possible. This is a few of the reasons this incentive structure has not been very successful over the years and has developed an unkind reputation in many sectors of the business world. With my Three Step Method for determining Commissions, the problems that I have mentioned are eliminated. Each new associate will only have to recruit three new associates. Each associate will have his five positions to break-even filled, and his remaining thirty-four positions will also be filled.

The Three Step Method for determining commissions is very simple. It involves only three steps. It positions new associates in a commission structure differently than in the past. By doing so, it greatly improves the earning capabilities of all associates. There are only three locations an associate can be positioned and only three locations he should position his three recruited associates.

“STEP 1” See (FIG. 2) All associates who start their bracket at “Step 1” position their three recruited associates at these locations (X #2, X #8, X #26)); level 1, level 2, level 3.

“STEP 2” See (FIG. 3) is “Step 1's” first recruited associate (X #2); level 1. He positions his first recruited associate (X #25); level 3. He positions his second recruited associate (X #9); level 2. He positions his third recruited associate (X #7); level 2.

“STEP 3” See (FIG. 4) is “Step 1's” second recruited associate (X #8); level 2. He positions his first recruited associate (X #27); level 3. He positions his second recruited associate (X #3); level 1. He positions his third recruited associate (X #1); level 1.

See (FIG. 5) This diagram illustrates the positions filled in a marketing bracket after Step 1, Step 2, and Step 3 have been completed once. When these three steps are repeated, the 39 positions in the marketing bracket will be filled with associates.

See (FIG. 6). This illustrates how all associates that are positioned to begin their commissions bracket at Step 1 will reach their “break-even” point described in paragraph (0005). Associate (0) recruits three associates; he places one associate on each of the three levels (X #2, X #8, X #26). His first recruited associate (X #2), level 1, positions his first recruited associate on (X #25), level three. His second recruited associate (X #8), level 2, places his first recruited associate on (X #27), level 3. At this time, associate (0) is at the “break-even point”. This represents Step 1 and the first aspects of Step 2 and Step 3.

What is claimed is:

1. A method for positioning associates to determine commissions paid to said associates, comprising:
“STEP 1” See (FIG. 2) All associates who start their bracket at “Step 1” position their three recruited associates at these locations (X #2, X #8, X #26)); level 1, level 2, level 3.
“STEP 2” [See (FIG. 3)] is “Step 1's” first recruited associate (X #2); level 1. He positions his first recruited associate (X #25); level 3. He positions his second recruited associate (X #9); level

2. He positions his third recruited associate (X #7); level 2.
“STEP 3” [See (FIG. 4)] is “Step 1's” second recruited associate (X #8); level 2. He positions his first recruited associate (X #27); level 3. He positions his second recruited associate (X #3); level 1. He positions his third recruited associate (X #1); level 1.
